(19) United States
(12) Patent Application Publication
(10) Pub. No.: US 2008/0114742 A1
(43) Pub. Date: May 15, 2008

(54) Object entity searching method and object entity searching device

(76) Inventors: You Ganmei, Beijing (CN); Li Gang, Beijing (CN); Lu Yaojie, Beijing (CN); Yin Yueyan, Beijing (CN); Zheng Jichuan, Beijing (CN)

Correspondence Address: DICKSTEIN SHAPIRO LLP, 1825 EYE STREET NW, Washington, DC, 20006-5403, US

(21) Appl. No.: 11/984,026

(22) Filed: Nov. 13, 2007

(30) Foreign Application Priority Data
Nov. 14, 2006 (CN) 200610144799.7

(51) Int. Cl. G06F 17/30

(52) U.S. Cl. 707/3; 707/E17.108

(57) ABSTRACT

An object-entity searching method is disclosed that is able to effectively utilize digital document information and generate candidate-entity document sets based on relationships between a digital document and an object entity, and able to improve precision of searching for an object entity. The method includes the steps of selecting field-digital documents related to each of plural candidate entities to form a candidate-entity field-document set, extracting a keyword sequence including at least one keyword according to a query input by a user, searching a current field-digital-document set to obtain a field-document set, dynamically selecting field documents related to each of the candidate entities to form a candidate-entity field-document set, calculating candidate-entity field-document values in the candidate-entity field document set, accumulating all of the candidate-entity field-document values of all of the fields corresponding to the candidate entities to obtain a candidate-entity document value, and selecting the object entity according to the candidate-entity document value.

### BACKGROUND OF THE INVENTION

1. Field of the Invention

The present invention relates to a method and a device for searching for an object entity in a document set based on known relationships between digital documents and the object entity.

2. Description of the Related Art

Along with progress in information technology and the Internet, network information has increased explosively, and successive progress is also being made in information searching techniques, which is a primary means for acquiring information. Requirements of users for information searching are not limited to finding a relevant document from digitalized documents according to a user's query. For a company or in the information field, it is often required to search for information hidden in a digitalized document set. For example, it may be required to search for an expert in a specified research field in a document set, or search for a company working in a certain business field in the document set. However, the information searching systems in the related art cannot deal with such kinds of search, or cannot satisfactorily deal with such kinds of search.

### SUMMARY OF THE INVENTION

The present invention may solve one or more problems of the related art.

A preferred embodiment of the present invention may provide an object entity searching method and an object entity searching device able to effectively utilize digital document information and generate candidate entity document sets based on relationships between a digital document and an object entity, and be able to improve precision of searching for an object entity by using candidate-entity document set information obtained from dynamically selected relevant documents at the time of searching for a candidate entity document.

According to a first aspect of the present invention, there is provided an object-entity searching method of searching M (M is an integer, and M≧1) fields for an object entity in a digital-document set including a plurality of digital documents, each digital document in the digital-document set being divided into N (N is an integer, and N≧M≧1) fields, said method comprising the steps of:

(a) selecting field-digital-documents related to each of a plurality of candidate entities in each of a plurality of field-digital-document sets according to known relationships between the digital documents and the candidate entities, said field-digital-document being a field of a digital document, said selected field-digital-documents forming a candidate-entity field-document, all of the candidate-entity field documents being related to one field forming a candidate-entity field-document set;

(b) extracting a keyword sequence including at least one keyword according to a query input by a user, said extracted keyword sequence being used as a current keyword sequence;

(c) selecting one field as a current field, and searching a current field-digital-document set to obtain a field-document set according to the current keyword sequence;

(d) dynamically selecting field documents related to each of the candidate entities, said selected field documents being related to all candidate entities forming a candidate-entity field-document set;

(e) calculating a value of each of the candidate-entity field documents in the candidate-entity field-document set according to the keyword sequence and the candidate-entity field-document set;

(f) repeating, if un-calculated fields exist in the known M fields, the steps (c), (d), (e), and (f) with one of the un-calculated fields as a current field, or

accumulating, if there is no un-calculated field in the known M fields, all of the candidate-entity field-document values of all of the fields corresponding to the candidate entities to obtain a candidate-entity document value; and

(g) selecting the object entity according to the candidate-entity document value.

According to a second aspect of the present invention, there is provided an object-entity searching device of searching M (M is an integer, and M≧1) fields for an object entity in a digital-document set including a plurality of digital documents, each digital document in the digital-document set being divided into N (N is an integer, and N≧M≧1) fields, said device comprising:

a candidate-entity field-document set generator that selects field-digital-documents related to each of a plurality of candidate entities in each of a plurality of field-digital-document sets, said field-digital-document being a field of a digital document, wherein the selected field-digital-documents form a candidate-entity field document, and all of the candidate-entity field documents related to one field form a candidate-entity field-document set;

a keyword sequence extractor that extracts a keyword sequence including at least one keyword according to a query input by a user, and uses the extracted keyword sequence as a current keyword sequence;

a field document search engine that selects one field as a current field, and searches a current field-digital-document set to obtain a field-document set according to the current keyword sequence;

a candidate-entity field-document set generator that dynamically selects field documents related to each of the candidate entities in a field-document set, wherein the selected field documents are related to all candidate entities forming a candidate-entity field-document set;

a candidate-entity document-value calculator that calculates the candidate-entity field-document values in the candidate-entity field-document set according to the keyword sequence and the candidate-entity field-document set;

a candidate-entity document-value accumulator that accumulates all of the candidate-entity field-document values; and

a candidate-entity selector that selects the object entity according to the candidate-entity document value.

According to the present invention, it is possible to efficiently improve precision of information searching. The present invention effectively utilizes relationships between digital document information and the candidate entity, and thus is able to relatively precisely calculate a candidate entity relevant to a user query, namely, the object entity. At the same time, the present invention is able to effectively improve searching precision.

These and other objects, features, and advantages of the present invention will become more apparent from the following detailed description of preferred embodiments given with reference to the accompanying drawings.

### BRIEF DESCRIPTION OF THE DRAWINGS

FIG. 1 is a block diagram illustrating an object entity searching device for searching for an object entity according to an embodiment of the present invention;

FIG. 2 is a flowchart illustrating an object-entity searching method for searching for an object entity according to the present embodiment of the present invention; and

FIG. 3 is a flowchart illustrating operations of object-entity searching by the object-entity searching device using the object entity-searching method of the present embodiment.

### DESCRIPTION OF THE PREFERRED EMBODIMENTS

Below, preferred embodiments of the present invention are explained with reference to the accompanying drawings.

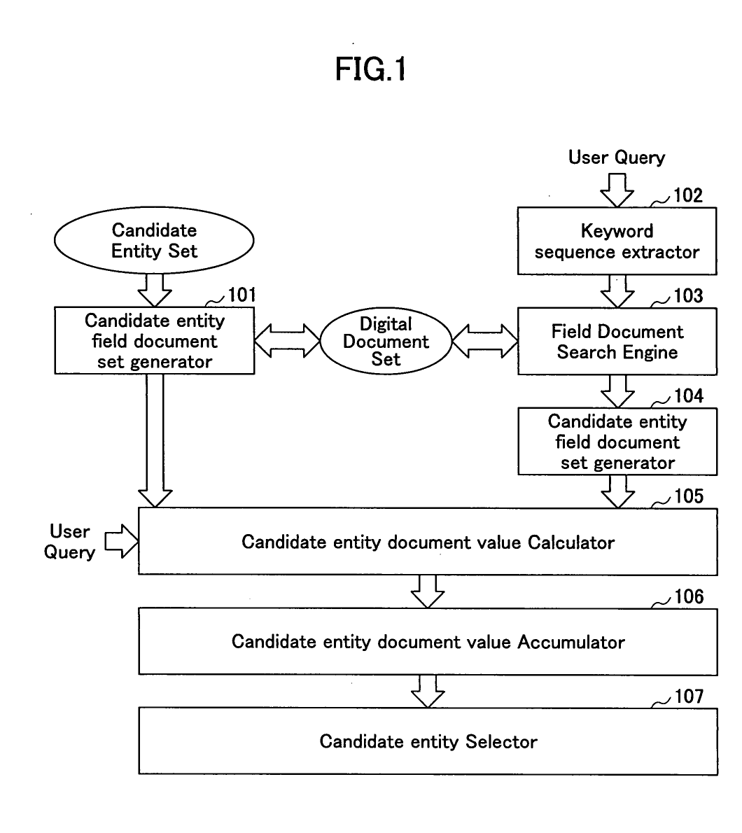

FIG. 1 is a block diagram illustrating an object-entity searching device for searching for an object entity according to an embodiment of the present invention.

The object-entity searching device shown in FIG. 1 is used for searching M (M is an integer, and M≧1) fields for an object entity in a digital-document set. The digital-document set includes plural digital documents, and each digital document in the digital-document set is divided into N (N is an integer, and N≧M≧1) fields. Here, M is given by a user, and indicates the number of fields to be searched. In other words, even when each digital document in the digital-document set has been divided into N fields, the user is still able to search only M fields of the digital-document set.

The object-entity searching device includes a candidate-entity field-document set generator 101, which selects all digital documents related to a current candidate entity in the current field-digital-document set, forms candidate-entity field-documents with the selected digital-documents, and further collects all of the candidate-entity field-documents to form a candidate-entity field-document set; a keyword sequence extractor 102, which extracts a keyword sequence including at least one keyword according to a query input by a user, and uses the extracted keyword sequence as a current keyword sequence; a field document search engine 103, which searches for a field document according to the current keyword sequence; a candidate-entity field-document set generator 104, which dynamically selects field documents related to the current candidate entity in the field-document set, and forms a candidate-entity field-document set with the selected field documents; a candidate-entity document-value calculator 105, which calculates candidate-entity field-document values in the candidate-entity field-document set according to the keyword sequence and the candidate-entity field-document set; a candidate-entity document-value accumulator 106, which accumulates all of the candidate-entity field-document values; and a candidate-entity selector 107, which selects the object entity according to the candidate-entity document value.

When calculating the candidate-entity field-document values in the first through M fields, if un-calculated fields exist in the M fields, one of the un-calculated fields is selected to be the current field, and the field document search engine 103, the candidate-entity field-document set generator 104, and the candidate-entity document-value calculator 105 execute operations as described above; otherwise, the candidate-entity document-value accumulator 106 and the candidate-entity selector 107 execute operations as described above.

The object-entity searching device of the present embodiment utilizes relationships between the digital documents and the candidate entities to generate the candidate-entity document set, and dynamically selects the field documents related to the current candidate entity to calculate the candidate-entity field-document values in the candidate-entity field-document set according to the keyword sequence and the candidate-entity field-document set to obtain the object entity. Hence, it is possible to effectively improve searching precision.

For example, the keyword may be a word or a phrase, and the field may include a subject, a title, an abstract, original data of the digital document, and data related to positions of entities in the document.

Further, the field-digital-document set may include digital-document sets not divided into fields. In doing so, it is possible to improve the versatility of the system.

When the candidate-entity field-document set generator 104 dynamically selects field documents related to the current candidate entity in the field-document set, for example, the candidate-entity field-document set generator 104 selects all field documents related to the current candidate entity from K (K is an integer, and K≧1) most relevant field documents. Alternatively, the candidate-entity field-document set generator 104 selects L (L is an integer, and L≧1) most relevant field documents related to the current candidate entity from the field document set.

When the candidate-entity document-value calculator 105 calculates candidate-entity field-document values, for example, the candidate-entity document-value calculator 105 performs calculations by using a query-based document length, namely, the length of the candidate-entity field document. Specifically, the candidate-entity document-value calculator 105 performs calculations by using a modified BM25 method, a modified DFR_BM25 method, a modified phrase method, a combination of the modified BM25 method and the modified phrase method, or a combination of the modified DFR_BM25 method and the modified BM25 method.

In the modified BM25 method, the query-based document length is used as a document length in a BM25 formula. In the modified DFR_BM25 method, the query-based document length is used as a document length in a DFR_BM25 formula.

The modified phrase method may include a modified BM25 phrase method and a modified DFR_BM25 phrase method. In the modified BM25 phrase method, a modified BM25 formula multiplied by a phrase length is used as a modified BM25 phrase formula, and the modified BM25 phrase formula is applied to a phrase.

In the modified DFR_BM25 phrase method, a modified DFR_BM25 formula multiplied by a phrase length is used as a modified DFR_BM25 phrase formula, and the modified DFR_BM25 phrase formula is applied to the phrase.

The combination includes a linear combination of the document values obtained by the above methods.

When the candidate-entity document-value accumulator 106 accumulates the candidate-entity field-document values, for example, the candidate-entity document-value accumulator 106 performs a linear combination.

When the candidate-entity selector 107 selects the object entity, for example, the candidate-entity selector 107 selects T (T is an integer, and T≧1) candidate entities corresponding to the largest T candidate-entity document values as the object entities.

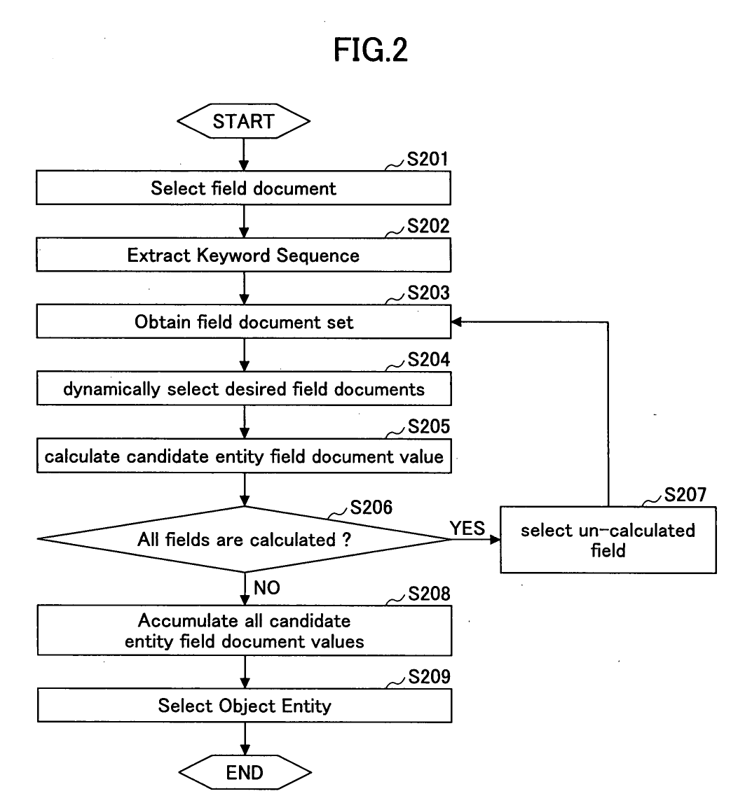

FIG. 2 is a flowchart illustrating an object-entity searching method for searching for an object entity according to the present embodiment of the present invention.

The object-entity searching method shown in FIG. 2 is for searching M (M is an integer, and M≧1) fields for an object entity in a digital-document set. The digital-document set includes plural digital documents, and each digital document in the digital-document set is divided into N (N is an integer, and N≧M≧1) fields. Here, M is given by a user, and indicates the number of fields to be searched. In other words, even when each digital document in the digital-document set has been divided into N fields, the user is still able to search only M fields of the digital-document set. Further, the relationship between the digital-documents and the candidate entities is known.

As shown in FIG. 2, in step S201, field-digital-documents related to all candidate entities are selected in plural field-digital-document sets according to the known relationship between the digital documents and the candidate entities. The field-digital-document is a field of a digital document. The selected field-digital-document forms a candidate-entity field document and all of the candidate-entity field documents related to one field form a candidate-entity field-document set.

In step S202, a keyword sequence is extracted according to a query input by a user. For example, the keyword sequence includes at least one keyword. The extracted keyword sequence is used as a current keyword sequence.

In step S203, one field is selected and regarded as a current field, and a current field-digital-document set is searched according to the current keyword sequence to obtain a field-document set.

In step S204, field documents related to each of the candidate entities are dynamically selected, and the selected field documents related to all candidate entities form a candidate-entity field-document set.

In step S205, the candidate-entity field-document values of the candidate-entity field documents in the candidate-entity field document set are calculated according to the keyword sequence and the candidate-entity field-document set.

In step S206, it is determined whether un-calculated fields exist in the known M fields.

If it is determined that un-calculated fields exist in the known M fields, the routine proceeds to step S207. Otherwise, the routine proceeds to step S208.

In step S207, since un-calculated fields exist in the known M fields, the steps 203, 204, 205, and 206 are repeated with one of the un-calculated fields as the current field.

In step S208, since un-calculated fields do not exist in the known M fields, all of the candidate-entity field-document values are accumulated over all of the fields corresponding to the candidate entities, thus, a candidate-entity document value is obtained.

In step S209, the object-entity is selected according to the thus obtained candidate-entity document value.

The object-entity searching method of the present embodiment utilizes relationships between the digital documents and the candidate entities to generate the candidate-entity document set, and dynamically selects the field documents related to the current candidate entity to calculate the candidate-entity field-document values in the candidate-entity field-document set according to the keyword sequence and the candidate-entity field-document set to obtain the object entity. Hence, it is possible to effectively improve searching precision.

For example, the keyword may be a word or a phrase, and the field may include a subject, a title, an abstract, original data of the digital document, and data related to positions of entities in the document.

Further, the field digital-document set may include digital-document sets not divided into fields. In doing so, it is possible to improve versatility of the system.

In step 204, when dynamically selecting the field documents related to the current candidate entity in the field-document set, for example, all field documents related to the current candidate entity from K (K is an integer, and K≧1) most relevant field documents are selected. Alternatively, L (L is an integer, and L≧1) most relevant field documents related to the current candidate entity are selected from the field-document set.

In step 205, when calculating the candidate-entity field-document values, for example, the calculations are performed by using the query-based document length, namely, the length of the candidate-entity field document. Specifically, the calculations are performed by the modified BM25 method, the modified DFR_BM25 method, the modified phrase method, the combination of the modified phrase method and the modified BM25 method, or the combination of the modified DFR_BM25 method and the modified BM25 method.

In the modified BM25 method, the query-based document length is used as the document length in the BM25 formula. In the modified DFR_BM25 method, the query-based document length is used as the document length in the DFR_BM25 formula.

The modified phrase method may include the modified BM25 phrase method and the modified DFR_BM25 phrase method. In the modified BM25 phrase method, the modified BM25 formula multiplied by the phrase length is used as the modified BM25 phrase formula, and the modified BM25 phrase formula is applied to a phrase.

In the modified DFR_BM25 phrase method, the modified DFR_BM25 formula multiplied by the phrase length is used as the modified DFR_BM25 phrase formula, and the modified DFR_BM25 phrase formula is applied on the phrase.

The combination includes linear combinations of the document values obtained by the above methods.

In the step 208, for example, the candidate-entity field-document values are accumulated by linear combinations.

In the step 209, when selecting the object-entity, for example, T (T is an integer, and T≧1) candidate entities corresponding to the largest T candidate-entity document values are selected as the object entities.

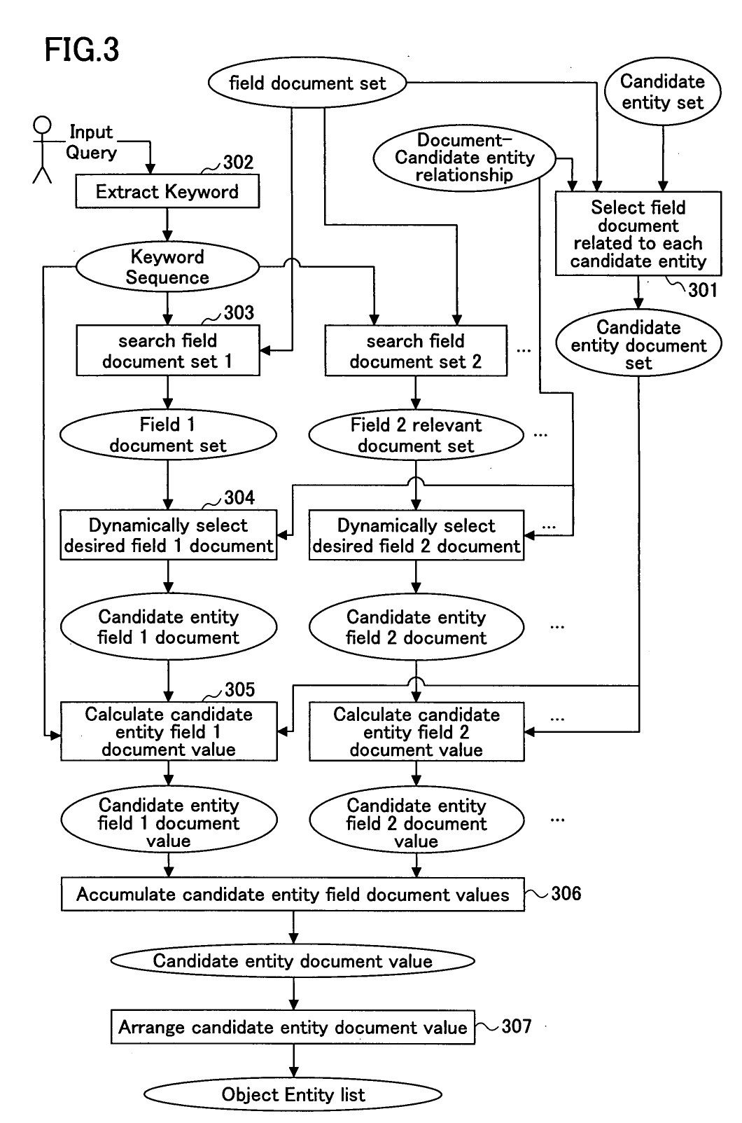

FIG. 3 is a flowchart illustrating operations of object-entity searching by the object-entity searching device using the object-entity searching method of the present embodiment.

In step 301, the candidate-entity field-document set generator 101 of the object-entity searching device of the present embodiment selects field-digital-documents related to all candidate-entity sets in plural field-digital-document sets according to the known relationships between the digital documents and the candidate-entity sets to generate a candidate-entity field-document set.

In step S302, a query is input by a user, and the keyword sequence extractor 102 extracts keywords according to the query and obtains a keyword sequence T (t1, t2, . . . ).

In step S303, the field document search engine 103 searches a field document set F1D (f1d1, f1d2, . . . ) of a field 1 by using the keyword sequence T, and obtains a field document set R1D (r1d1, r1d2, . . . ) related to the field 1.

In step S304, the candidate-entity field document set generator 104 dynamically selects field 1-relevant documents related to the candidate entities in the field 1 document set according to the relationships between the digital documents and the candidate-entity sets, and obtains a document set RE1 related to the candidate entities in the field 1.

In step S305, the candidate-entity document-value calculator 105 calculates the candidate-entity field-document values of the candidate entities in the field 1 according to the keyword sequence T and the document set RE1 related to the candidate entities in the field 1.

Then, in a field 2, similarly, the object-entity searching device repeats the steps 303, 304, 305 to obtain candidate-entity field-document values of the candidate entities in the field 2.

This procedure is repeated to calculate candidate-entity field-document values of the candidate entities in all fields selected by the user.

In step S306, the candidate-entity document-value accumulator 106 accumulates all of the obtained candidate-entity field-document values to obtain a candidate-entity document value.

In step S307, the candidate-entity selector 107 selects n (n is an integer, and n≧1) candidate entities corresponding to n candidate-entity document values as the object entities.

For example, assume information about computer experts and research fields of the computer experts is available in a web page set on a website (for example, www.w3.org), and a user intends to find computer experts in a specified research field from the web page set on the website. Thus, the question can be reduced as follows.

Assume a document set D (d1, d2, . . . ) represents the web page set on the above website, and each web page in the web page set includes plural fields, for example, a title, an abstract, a subtitle, keywords, and the main text portion of each web page. Hence, the document set D can be divided into plural field sets, such as a title set F1D, an abstract set F2D, . . . . Further, F1D can be expressed as F1D (f1d1, f1d2, . . . ), and F2D can be expressed as F2D (f2d1, f2d2, . . . ), . . . . Here, f1d1 represents data of the web page 1 in the field 1 (F1D), f1d2 represents data of the web page 2 in the field 1 (F1D), f2d1 represents data of the web page 1 in the field 2 (F2D), f2d2 represents data of the web page 2 in the field 2 (F2D), . . . .

A list of all of the experts is expressed by a candidate entity set EX (ex1, ex2, . . . ), and the object is to find a list of computer experts in the specified research field Q from the document set D and the field document set D.

For this purpose, the relationships between the documents and the entities, namely, between web pages and experts, are established based on information of the experts on each of the web pages.

First, according to the relationships between web pages and experts, for each expert appearing on the web pages, and for each field, all of the web pages including information about the expert are combined, thus obtaining field sets about each expert, for example, expert 1 (title set, abstract set, . . . ), expert 2 (title set, abstract set, . . . ).

Then, using an expression in a user-input field as a query expression, the keyword extractor 102 extracts keywords from the query expression and obtains the keyword sequence T (t1, t2, . . . ).

Then, the field document search engine 103 searches the first field, namely, the title set F1D (f1d1, f1d2, . . . ), by using the keyword sequence T, and obtains a relevant title set. Then, according to the relationship between web pages and experts, relevant title sets of all experts are obtained.

Then, according to the title sets and the relevant title sets of all experts, the candidate-entity document-value calculator 105 calculates expert-title field-document values by using appropriate searching methods, such as the modified BM25 method, in which the total length of the candidate-expert title-field documents is used as the document length in the BM25 formula.

The above procedure is repeated to calculate the document values of the experts in all other fields.

Then, the document values of the experts are weighted and accumulated over all of the fields. For example, important ones have high weight, such as the titles and subtitles. In this way, document values of respective experts are obtained. For example, these document values are arranged in descending order, and experts corresponding to the first n document values are selected and returned as search results.

In the present invention, since the relationships between the digital documents and the candidate entities are utilized to generate the candidate-entity document set, and the field documents related to the current candidate entity are dynamically selected, according to the keyword sequence, to calculate the candidate-entity field-document values and further to obtain the object entity, it is possible to effectively improve searching precision.

While the present invention is described with reference to specific embodiments chosen for purpose of illustration, it should be apparent that the invention is not limited to these embodiments, but numerous modifications could be made thereto by those skilled in the art without departing from the basic concept and scope of the invention.

This patent application is based on Chinese Priority Patent Application No. 200610144799 filed on Nov. 14, 2006, the entire contents of which are hereby incorporated by reference.

What is claimed is:

1. An object-entity searching method of searching M (M is an integer, and M≧1) fields for an object entity in a digital-document set including a plurality of digital documents, each digital document in the digital-document set being divided into N (N is an integer, and N≧M≧1) fields, said method comprising the steps of:
(a) selecting field-digital-documents related to each of a plurality of candidate entities in each of a plurality of field-digital-document sets according to a known relationship between the digital documents and the candidate entities, said field-digital-document being a field of a digital document, said selected field-digital-documents forming a candidate-entity field document, all of the candidate-entity field documents being related to one field forming a candidate-entity field-document set;
(b) extracting a keyword sequence including at least one keyword according to a query input by a user, said extracted keyword sequence being used as a current keyword sequence;
(c) selecting one field as a current field, and searching a current field-digital-document set to obtain a field-document set according to the current keyword sequence;
(d) dynamically selecting field documents related to each of the candidate entities, said selected field documents being related to all candidate entities forming a candidate-entity field-document set;
(e) calculating a value of each of the candidate-entity field documents in the candidate-entity field-document set according to the keyword sequence and the candidate-entity field-document set;
(f) repeating, if un-calculated fields exist in the known M fields, the steps (c), (d), (e), and (f) with one of the un-calculated fields as a current field, or
accumulating, if there is no un-calculated field in the known M fields, all of the candidate-entity field-document values of all of the fields corresponding to the candidate entities to obtain a candidate-entity document value; and
(g) selecting the object entity according to the candidate-entity document value.

2. The object-entity searching method as claimed in claim 1, wherein the field includes a subject, a title, an abstract, original data of the digital document, and data related to positions of entities in the document.

3. The object-entity searching method as claimed in claim 1, wherein the field digital-document set includes digital-document sets not divided into fields.

4. The object-entity searching method as claimed in claim 1, wherein the keyword includes a word or a phrase.

5. The object-entity searching method as claimed in claim 1, wherein the step (d) includes the step of selecting, from K (K is an integer, and K≧1) most relevant field documents, all field documents related to the current candidate entity.

6. The object-entity searching method as claimed in claim 1, wherein the step (d) includes the step of selecting L (L is an integer, and L≧1) most relevant field documents related to the current candidate entity from the field document set.

7. The object-entity searching method as claimed in claim 1, wherein the step (e) includes a step of performing the calculation by a method of using a query-based document length.

8. The object-entity searching method as claimed in claim 7, wherein the query-based document length is a length of the candidate-entity field document.

9. The object-entity searching method as claimed in claim 7, wherein the method of using the query-based document length includes one of a modified BM25 method, a modified DFR_BM25 method, a modified phrase method, a combination of the modified BM25 method and the modified phrase method, and a combination of the modified DFR_BM25 method and the modified BM25 method.

10. The object-entity searching method as claimed in claim 9, wherein in the modified BM25 method, the query-based document length is used as a document length in a BM25 formula.

11. The object-entity searching method as claimed in claim 9, wherein in the modified DFR_BM25 method, the query-based document length is used as a document length in a DFR_BM25 formula.

12. The object-entity searching method as claimed in claim 9, wherein the modified phrase method includes a modified BM25 phrase method and a modified DFR_BM25 phrase method.

13. The object-entity searching method as claimed in claim 12, wherein in the modified BM25 phrase method, a modified BM25 formula multiplied by a phrase length is used as a modified BM25 phrase formula.

14. The object-entity searching method as claimed in claim 12, wherein in the modified DFR_BM25 phrase method, a modified DFR_BM25 formula multiplied by a phrase length is used as a modified DFR_BM25 phrase formula.

15. The object-entity searching method as claimed in claim 9, wherein the combination includes a linear combination of the document values obtained by the plural methods.

16. The object-entity searching method as claimed in claim 1, wherein in the step (f), the step of accumulating includes a linear combination.

17. The object-entity searching method as claimed in claim 1, wherein the step (g) includes a step of selecting T (T is an integer, and T≧1) candidate entities corresponding to the largest T candidate-entity document values as the object entities.

18. An object-entity searching device of searching M (M is an integer, and M≧1) fields for an object entity in a digital-document set including a plurality of digital documents, each digital document in the digital-document set being divided into N (N is an integer, and N≧M≧1) fields, said device comprising:
a candidate-entity field-document set generator that selects field-digital-documents related to each of a plurality of candidate entities in each of a plurality of field-digital-document sets, said field-digital-document being a field of a digital document, wherein the selected field-digital-documents form a candidate-entity field document, and all of the candidate-entity field documents related to one field form a candidate-entity field-document set;
a keyword sequence extractor that extracts a keyword sequence including at least one keyword according to a query input by a user, and uses the extracted keyword sequence as a current keyword sequence;
a field document search engine that selects one field as a current field, and searches a current field-digital-document set to obtain a field-document set according to the current keyword sequence;
a candidate-entity field-document set generator that dynamically selects field documents related to each of the candidate entities in a field-document set, wherein the selected field documents related to all candidate entities form a candidate-entity field-document set;
a candidate-entity document-value calculator that calculates the candidate-entity field-document values in the candidate-entity field-document set according to the keyword sequence and the candidate-entity field-document set;
a candidate-entity document-value accumulator that accumulates all of the candidate-entity field-document values; and
a candidate-entity selector that selects the object entity according to the candidate-entity document value.
